(19) United States
(12) Patent Application Publication
(10) Pub. No.: US 2014/0115510 A1
(43) Pub. Date: Apr. 24, 2014

(54) Information Processing Method And Electronic Device

(71) Applicants: Lenovo (Beijing) Co., Ltd., Beijing (CN); Beijing Lenovo Software Ltd., Beijing (CN)

(72) Inventor: Qian Zhao, Beijing (CN)

(73) Assignees: Lenovo (Beijing) Co., Ltd., Beijing (CN); Beijing Lenovo Software Ltd., Beijing (CN)

(21) Appl. No.: 14/059,677

(22) Filed: Oct. 22, 2013

(30) Foreign Application Priority Data
Oct. 23, 2012 (CN) 201210407101.1

(51) Int. Cl. G06F 3/01; G06F 3/0488; G06F 3/0484

(52) U.S. Cl. CPC G06F 3/016; G06F 3/04847; G06F 3/0488
USPC 715/765

(57) ABSTRACT

An information processing method and an electronic device are described. The information processing method is applied to an electronic device having a touch display unit that can display one or more interactive objects. The method includes receiving a first touch operation on the interactive object from a first user and being used to execute a first instruction that is for changing a first parameter of the interactive object; judging whether the first parameter of the interactive object has been successfully changed or not, and obtaining a first judgment result; executing a first touch feedback when the first judgment result indicates that the first parameter of the interactive object has been successfully changed; and executing a second touch feedback when the first judgment result indicates that the first parameter of the interactive object cannot be successfully changed.

This application claims priority to Chinese patent application No. 201210407101.1 filed on Oct. 23, 2012, the entire contents of which are incorporated herein by reference.

### BACKGROUND

The present disclosure relates to the field of information technology, and more particularly, to an information processing method and an electronic device.

With the development of global informationization technology, more and more electronic devices such as mobile phones, laptops, all-in-one machines, and so on appear in people's life. And with the evolution of electronic devices, operations executable in the electronic devices such as browsing pictures, editing files, playing games, and so on have also become more and more diversified.

Wherein, picture zooming-in or zooming-out will be involved when browsing pictures. Under normal circumstances, an electronic device can zoom-in or zoom-out a picture by way of responding to a user's clicking on a zoom-in button or a zoom-out button, or by way of responding to a sliding operation of the user's fingers on a touch screen.

During the process of implementing technical solutions of embodiments of the present application, the inventor of the present application has found that the prior arts at least have the following technical problems:

In the prior arts, after the electronic device responds to the user' first touch operation and thereby executes a first instruction that is for changing a first parameter of an interactive object, the interactive object may be capable of responding to the first instruction, or may also be incapable of responding thereto. However, no touch feedback information that prompts whether the interactive object is capable of responding to the first instruction or not is generated in the prior arts. That is, in the prior arts, there is a technical problem of being incapable of prompting whether the first parameter of the interactive object can be successfully changed or not. This, in turn, causes the user to perform the first touch operation repeatedly, which thereby results in a waste of time and resources, and thus reduces the user's experience degree.

For example, during the process of zooming in a picture, even when the picture has been zoomed in to the maximum, the electronic device will still generate a zoom-in instruction, but it will not respond to this zoom-in instruction. However, since no corresponding prompt information is generated, this causes the user to perform the zoom-in operation repeatedly, thus wasting the user's time and also reducing the user's experience degree.

### SUMMARY

The present application provides an information processing method and an electronic device for solving the technical problem of being incapable of prompting whether a first parameter of an interactive object can be successfully changed or not in the prior arts.

In one aspect, an embodiment of the present application provides the following technical solutions:

An information processing method applied to an electronic device having a touch display unit that can display one or more interactive objects, the method comprising:

receiving a first touch operation on the interactive object from a first user, the first touch operation being used to execute a first instruction that is for changing a first parameter of the interactive object;

judging whether the first parameter of the interactive object has been successfully changed or not, and obtaining a first judgment result;

executing a first touch feedback when the first judgment result indicates that the first parameter of the interactive object has been successfully changed; and

executing a second touch feedback when the first judgment result indicates that the first parameter of the interactive object cannot be successfully changed.

Optionally, when the interactive object is an image object, the judging whether the first parameter of the interactive object has been successfully changed or not particularly is:

judging whether a display size of the image object has been successfully changed or not.

Optionally, when the interactive object is a navigation control object, the judging whether the first parameter of the interactive object has been successfully changed or not particularly is:

judging whether a distance of the navigation control object with respect to a first position has been successfully changed or not.

Optionally, when the interactive object is an icon object corresponding to at least one short message, the judging whether the first parameter of the interactive object has been successfully changed or not particularly is:

judging whether a display area of the icon object has been successfully changed or not.

Optionally, when the interactive object is a progress bar, the judging whether the first parameter of the interactive object has been successfully changed or not particularly is:

judging whether a valid progress value of the progress bar has been successfully changed or not.

Optionally, the executing a first touch feedback when the first judgment result indicates that the first parameter of the interactive object has been successfully changed particularly includes:

generating a first prompt instruction when the first judgment result indicates that the first parameter of the interactive object has been successfully changed; and

executing the first prompt instruction to generate first prompt information, the first prompt information particularly being: prompt information prompting the first user that the interactive object has been successfully changed.

Optionally, the executing a second touch feedback when the first judgment result indicates that the first parameter of the interactive object cannot be successfully changed particularly includes:

generating a second prompt instruction when the first judgment result indicates that the first parameter of the interactive object cannot be successfully changed; and

executing the second prompt instruction to generate second prompt information, the second prompt information particularly being: prompt information prompting the first user that the interactive object cannot be successfully changed.

Optionally, the first prompt information particularly is: prompt information that prompts by way of adopting first preset voice information; or prompt information that prompts by adopting a first preset vibration mode; or prompt information that prompts by adopting a first haptic feedback mode.

Optionally, the first haptic feedback mode particularly is: a feedback mode of generating a static electricity with a first preset electrostatic value on a surface of the touch display unit; or

the first haptic feedback mode particularly is: a feedback mode of adopting a first preset number of motors to vibrate.

Optionally, the second prompt information particularly is: prompt information that prompts by way of adopting second preset voice information; or prompt information that prompts by adopting a second preset vibration mode; or prompt information that prompts by adopting a second haptic feedback mode.

Optionally, the second haptic feedback mode particularly is: a feedback mode of generating a static electricity with a second preset electrostatic value on a surface of the touch display unit; or

the second haptic feedback mode particularly is: a feedback mode of adopting a second preset number of motors to vibrate.

In another aspect, another embodiment of the present application provides the following technical solutions:

An electronic device having a touch display unit that can display one or more interactive objects, the electronic device comprising:

a receiving module for receiving a first touch operation on the interactive object from a first user, the first touch operation being used to execute a first instruction that is for changing a first parameter of the interactive object;

a judging module for judging whether the first parameter of the interactive object has been successfully changed or not, and obtaining a first judgment result;

a first executing module for executing a first touch feedback when the first judgment result indicates that the first parameter of the interactive object has been successfully changed; and

a second executing module for executing a second touch feedback when the first judgment result indicates that the first parameter of the interactive object cannot be successfully changed.

Optionally, when the interactive object is an image object, the judging module is particularly for:

judging whether a display size of the image object has been successfully changed or not.

Optionally, when the interactive object is a navigation control object, the judging module is particularly for:

judging whether a distance of the navigation control object with respect to a first position has been successfully changed or not.

Optionally, when the interactive object is an icon object corresponding to at least one short message, the judging module is particularly for:

judging whether a display area of the icon object has been successfully changed or not.

Optionally, when the interactive object is a progress bar, the judging module is particularly for:

judging whether a valid progress value of the progress bar has been successfully changed or not.

Optionally, the first executing module particularly includes:

a first generating unit for generating a first prompt instruction when the first judgment result indicates that the first parameter of the interactive object has been successfully changed; and

a first executing unit for executing the first prompt instruction to generate first prompt information, the first prompt information particularly being: prompt information prompting the first user that the interactive object has been successfully changed.

Optionally, the second executing module particularly includes:

a second generating unit for generating a second prompt instruction when the first judgment result indicates that the first parameter of the interactive object cannot be successfully changed; and

a second executing unit for executing the second prompt instruction to generate second prompt information, the second prompt information particularly being: prompt information prompting the first user that the interactive object cannot be successfully changed.

Optionally, the first prompt information particularly is: prompt information that prompts by way of adopting first preset voice information; or prompt information that prompts by adopting a first preset vibration mode; or prompt information that prompts by adopting a first haptic feedback mode.

Optionally, the first haptic feedback mode particularly is: a feedback mode of generating a static electricity with a first preset electrostatic value on a surface of the touch display unit; or

the first haptic feedback mode particularly is: a feedback mode of adopting a first preset number of motors to vibrate.

Optionally, the second prompt information particularly is: prompt information that prompts by way of adopting second preset voice information; or prompt information that prompts by adopting a second preset vibration mode; or prompt information that prompts by adopting a second haptic feedback mode.

Optionally, the second haptic feedback mode particularly is: a feedback mode of generating a static electricity with a second preset electrostatic value on a surface of the touch display unit; or

the second haptic feedback mode particularly is: a feedback mode of adopting a second preset number of motors to vibrate.

One or more technical solutions provided in the embodiments of the present application at least have the following technical effects or advantages:

(1) In the embodiments of the present application, after the electronic device receives the first touch operation on the interactive object from the first user, it will judge whether the first instruction executed based on the first touch operation can change the first parameter of the interactive object or not, and further generate different touch feedbacks based on whether the first parameter can be successively changed or not, therefore the technical problem of being incapable of prompting whether the first parameter of the interactive object can be successfully changed or not in the prior arts is solved, and the technical effect of generating different touch feedbacks based on whether the first parameter of the interactive object can be successfully changed or not is achieved;

(2) In the embodiments of the present application, the interactive object may be multiple types of interactive objects, such as image objects, navigation control objects, icon objects, progress bars, etc., and the first touch operations on these multiple types of interactive objects all can generate corresponding touch feedbacks, therefore the technical effect that the control over the electronic device becomes more diversified is achieved; and

(3) In the embodiments of the present application, the first touch feedback or the second touch feedback can be executed by adopting multiple modes, such as the feedback mode adopting voice prompt, the feedback mode adopting vibration, the feedback mode adopting haptic impression, etc., therefore the technical effect that the feedback modes to the touch operations become more diversified is achieved.

### BRIEF DESCRIPTION OF THE DRAWINGS

FIG. 1 is a flowchart of an information processing method in a first embodiment of the present application;

FIG. 2 is a flowchart of executing a first touch feedback in the first embodiment of the present application;

FIG. 3 is a flowchart of executing a second touch feedback in the first embodiment of the present application; and

FIG. 4 is a block diagram of an electronic device in a third embodiment of the present application.

### DETAILED DESCRIPTION

The present application provides an information processing method and an electronic device for solving the technical problem of being incapable of prompting whether a first parameter of an interactive object can be successfully changed or not in the prior arts.

In order to solve the above technical problem, a general concept of technical solutions of embodiments in the present application is as follows:

First receiving a first touch operation on the interactive object from a first user, the first touch operation being used to execute a first instruction that is for changing a first parameter of the interactive object; then judging whether the first parameter has been successfully changed or not, and obtaining a first judgment result; executing a first touch feedback when the first judgment result indicates that the first parameter of the interactive object has been successfully changed; and executing a second touch feedback when the first judgment result indicates that the first parameter of the interactive object cannot be successfully changed.

As a result of adopting the above solution, after the electronic device receives the first touch operation on the interactive object from the first user, it will judge whether the first instruction executed based on the first touch operation can change the first parameter of the interactive object or not, and further generate different touch feedbacks based on whether the first parameter can be successively changed or not, therefore the technical problem of being incapable of prompting whether the first parameter of the interactive object can be successfully changed or not in the prior arts is solved, and the technical effect of generating different touch feedbacks based on whether the first parameter of the interactive object can be successfully changed or not is achieved.

To better understand the above technical solution, hereinafter the above technical solution will be described in detail with reference to the accompanying drawings and the specific implementations.

### First Embodiment

The first embodiment of the present application provides an information processing method applied to an electronic device having a touch display unit that can display one or more interactive objects. The electronic device, for example, is a mobile phone, a tablet PC, a laptop, etc., and it will not be exemplified in detail and restricted that what kind of electronic device it is in this embodiment; while the interactive object, for example, is an image object, a navigation control object, an icon object, a progress bar, etc., and it will not be exemplified in detail and restricted that what kind of object the interactive object is in this embodiment.

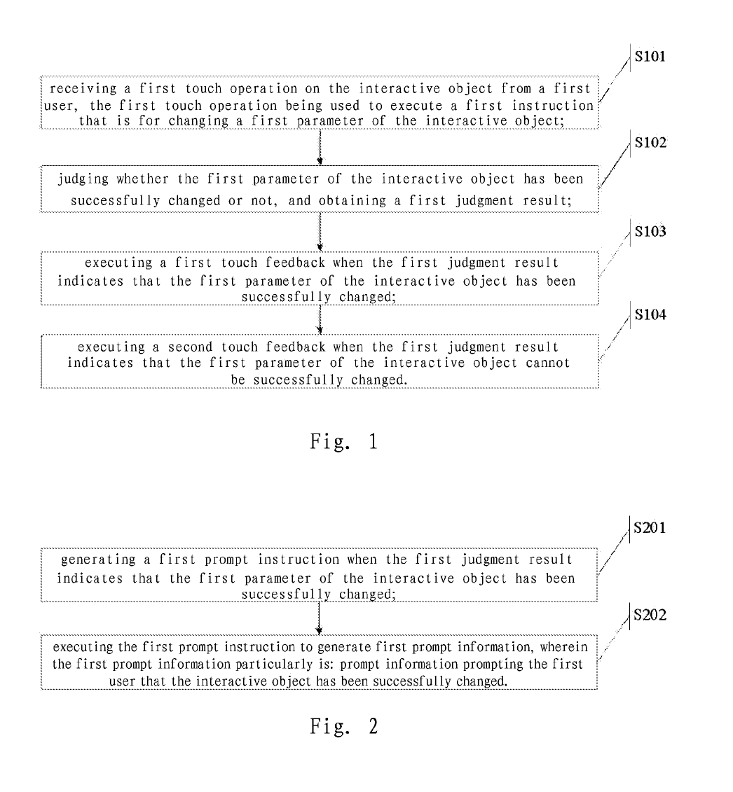

Referring to FIG. 1, the information processing method comprises the following steps:

Step S101: receiving a first touch operation on the interactive object from a first user, the first touch operation being used to execute a first instruction that is for changing a first parameter of the interactive object;

Step S102: judging whether the first parameter of the interactive object has been successfully changed or not, and obtaining a first judgment result;

Step S103: executing a first touch feedback when the first judgment result indicates that the first parameter of the interactive object has been successfully changed; and

Step S104: executing a second touch feedback when the first judgment result indicates that the first parameter of the interactive object cannot be successfully changed.

Wherein, in step S101, the first touch operation may be an arbitrary operation, such as a single-click operation, a sliding operation, a double-click operation, etc. And after the touch display unit receives the first touch operation, it will generate a first instruction for changing the first parameter of the interactive object and corresponding to the first touch operation. Wherein, based on different interactive objects and/or different touch operations, the first instructions are different, and thereby the changed first parameters of the interactive objects are also different.

Wherein, in step S102, based on different interactive objects, the judging processes are different. Several of these cases will be exemplified below for introduction, and it is certainly not limited to the following several cases in the specific implementing process.

In a first case, when the interactive object is an image object, the judging whether the first parameter of the interactive object has been successfully changed or not particularly is:

judging whether a display size of the image object has been successfully changed or not.

In the particular implementing process, when the user is browsing the image object, usually a zoom-in or zoom-out operation will be performed on the image object. However, under normal circumstances, the maximum display size of the image object or the minimum display size thereof is limited. When the image object is zoomed in to the limit size or zoomed out to the limit size, even if an operation of zooming in or zooming out the image object is again received, the display size of the image object will no longer be changed.

In a second case, when the interactive object is a navigation control object, the judging whether the first parameter of the interactive object has been successfully changed or not particularly is:

judging whether a distance of the navigation control object with respect to a first position has been successfully changed or not.

In the specific implementing process, many web pages or text files contain navigation control objects, the movement of which can be controlled through the user's first touch operation, so that display contents of web pages or text files can be controlled to change. For example, the navigation control object is moved to the top to display contents at the top of a web page or a text file, or the navigation control object is moved to the bottom to display contents at the bottom of the web page or the text file, and so on. Wherein, the first position may be an arbitrary position on a web page or a text file, such as top, bottom, middle, and so on of the web page or the text file. Different display contents of the web page or the text file can be determined based on different distances between the navigation control object and the first position. And if the distance of the navigation control object with respect to the first position cannot be successfully changed, it means that the navigation control object is located at the top or the bottom of the web page or the text file, and there is no more web page or text content to be displayed.

In a third case, when the interactive object is an icon object corresponding to at least one short message, the judging whether the first parameter of the interactive object has been successfully changed or not particularly is:

judging whether a display area of the icon object has been successfully changed or not.

In the specific implementing process, when the electronic device is a mobile phone, if the mobile phone receives at least one short message, there will be at least one icon object corresponding to this short message. Wherein, the at least one icon object can be moved to different positions by responding to different operations of the user so as to cause the display area thereof to change. However, when the at least one icon object is at an edge of a display screen of the mobile phone, for example, when the display area of the at least one icon object is at the leftmost edge on the display screen of the mobile phone, the display area of the icon object cannot be successfully changed even if the first instruction generated based on the user's first touch operation is to continue moving the display area of the icon object to the left.

In a fourth case, when the interactive object is a progress bar, the judging whether the first parameter of the interactive object has been successfully changed or not particularly is:

judging whether a valid progress value of the progress bar has been successfully changed or not.

In the specific implementing process, the progress bar can be applied in many scenarios, for example, to adjust the display brightness of the display screen, adjust the volume of sound, adjust the playback progress, and so on. Certainly, it may also be applied in other scenarios, which will not be exemplified in detail and restricted in this embodiment.

Under normal circumstances, the progress bar will usually contain a valid progress value, for example:

If the progress bar is one to adjust the display brightness of the display screen, it will contain a valid brightness range, such as 0 to 10. Certainly, it may also be other values, and no restriction is made in the present application;

If the progress bar is one to adjust the volume of sound, it will contain a valid sound range, such as 0 to 100 dB. Certainly, it may also be other values, and no restriction is made in the present application;

If the progress bar is one to adjust the playback progress, it will contain a valid playback time range, such as 0 to 45 min. Certainly, it may also be other values, and no restriction is made in the present application.

Accordingly, when the valid progress of the progress bar reaches the maximum value, its valid progress value will not change, but still maintain the maximum value even if its progress value continues to be increased; and when the valid progress of the progress bar reaches the minimum value, the valid progress value will not change, but still maintains the minimum value even if its progress value continues to be decreased.

From the above description, it can be known that, in the embodiments of the present application, the interactive object may be multiple types of interactive objects, such as image objects, navigation control objects, icon objects, progress bars, etc., and the first touch operations on these multiple types of interactive objects all can generate corresponding touch feedbacks, therefore the technical effect that the control over the electronic device becomes more diversified is achieved.

Wherein, referring to FIG. 2, step S103 may be further divided into the following steps:

Step S201: generating a first prompt instruction when the first judgment result indicates that the first parameter of the interactive object has been successfully changed; and

Step S202: executing the first prompt instruction to generate first prompt information, wherein the first prompt information particularly is: prompt information prompting the first user that the interactive object has been successfully changed.

In the specific implementing process, the first prompt information may be a variety of prompt information, several among which will be exemplified below for introduction, and it is certainly not limited to the following several cases in the specific implementing process.

In a first case, the first prompt information particularly is: prompt information that prompts by way of adopting first preset voice information.

In the specific implementing process, the first preset voice information may be any voice information, such as a piece of ringtone, a piece of music, or a segment of prompt text, and it is not restricted that what kind of voice information the first preset voice information is in the present application.

In a second case, the first prompt information particularly is: prompt information that prompts by adopting a first preset vibration mode.

For example, a housing of the electronic device vibrates leftward twice, a mouse of the electronic device vibrates once, and so on. The first preset vibration mode may be any vibration mode, which will not be exemplified in detail and restricted in the embodiments of the present application.

In a third case, the first prompt information particularly is: prompt information that prompts by adopting a first haptic feedback mode.

And in the specific implementing process, the first haptic feedback mode may be further divided into a number of situations, several among which will be exemplified below for introduction, and it is certainly not restricted to the following several situations in the specific implementing process.

\textcircled{1} A feedback mode of generating a static electricity with a first preset electrostatic value on a surface of the touch display unit.

In the specific implementing process, when a static electricity is generated on the surface of the touch display unit, based on different electrostatic values, the first user's haptic impressions are different. For example, if the value set for the first preset electrostatic value is relatively small, the first user will feel like touching glass when the fingers of the user slide on the touch display unit. It is certainly not restricted in the embodiments of the present application that what value the first preset electrostatic value is in the specific implementing process.

\textcircled{2} A feedback mode of adopting a first preset number of motors to vibrate.

In the specific implementing process, a plurality of motors may be set under the touch display unit of the electronic device, then different numbers of motors are adopted to vibrate based on different first judgment results, thereby making the fingers of the first user have different haptic impressions.

\textcircled{3} A feedback mode of generating a first preset number of bumps on the surface of the touch display unit.

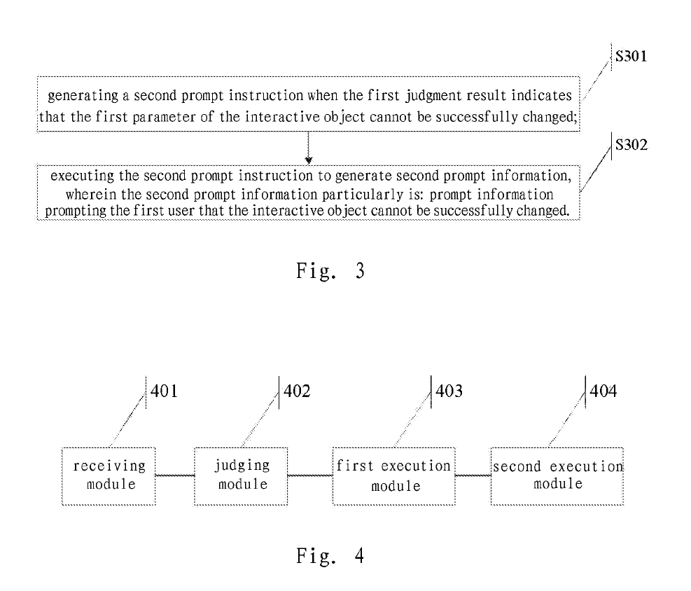

In the specific implementing process, the touch display unit may be a flexible touch display unit, on the substrate of which a plurality of dot matrix are set, and then the surface of the flexible touch display unit is enabled to display a first preset number of bumps only by controlling the plurality of dot matrix, so as to prompt the first user that the first parameter of the interactive object has been successfully changed.

Wherein, referring to FIG. 3, Step S104 may be further divided into the following steps:

Step S301: generating a second prompt instruction when the first judgment result indicates that the first parameter of the interactive object cannot be successfully changed; and

Step S302: executing the second prompt instruction to generate second prompt information, wherein the second prompt information particularly is: prompt information prompting the first user that the interactive object cannot be successfully changed.

In the specific implementing process, the second prompt information may be a variety of prompt information, several among which will be exemplified below for introduction, and it is certainly not limited to the following several cases in the specific implementing process.

In a first case, the second prompt information particularly is: prompt information that prompts by way of adopting second preset voice information.

In the specific implementing process, the second preset voice information is similar to the first preset voice information, such as a piece of ringtone, a piece of music, or a segment of prompt text, etc., and it is not restricted that what kind of voice information the second voice information is in the present application.

In a second case, the second prompt information particularly is: prompt information that prompts by adopting a second preset vibration mode.

For example, a housing of the electronic device vibrate rightward twice, a mouse of the electronic device vibrates twice, etc., and similar to the first preset vibration mode, it is not exemplified and restricted that what kind of vibration mode the second preset vibration mode is in the embodiments of the present application.

In a third case, the second prompt information particularly is: prompt information that prompts by adopting a second haptic feedback mode.

Wherein, the second haptic feedback mode may be further divided into a number of situations, three among which will be exemplified below for introduction, and it is certainly not limited to the following three situations in the specific implementing process.

\textcircled{1} A feedback mode of generating a static electricity with a second preset electrostatic value on a surface of the touch display unit.

For example, if the value set for the second preset electrostatic value is relatively large, the first user will feel like touching wood when the fingers of the user slide on the touch display unit. It is certainly not restricted in the embodiments of the present application that what value the second preset electrostatic value is in the specific implementing process.

\textcircled{2} A feedback mode of adopting a second preset number of motors to vibrate.

In the specific implementing process, in order to show difference, the second preset number of the motors is different from the first preset number of motors, so as to generate a different haptic feedback.

\textcircled{3} A feedback mode of generating a second preset number of bumps on the surface of the touch display unit.

In the specific implementing process, the first preset number and the second preset number are different, so as to generate different touch feedbacks.

From the above description, it can be known that, in the embodiments of the present application, the first touch feedback or the second touch feedback can be executed by adopting multiple modes, such as the feedback mode adopting voice prompt, the feedback mode adopting vibration, the feedback mode adopting haptic impression, etc., therefore the technical effect that the feedback modes to the touch operations become more diversified is achieved.

### Second Embodiment

In order to make those skilled in the art more clearly understand the specific application environment of the information processing method introduced in the first embodiment of the present application, the specific application of the information processing method will be introduced in detail below from the view of the user side. Wherein, Introduction is made, for example, with the electronic device being a tablet PC, the touch display unit being a display screen of the electronic device, and the interactive object being an image. Wherein, the image can be zoomed in three times, the first touch feedback mode is a feedback mode adopting a relatively small electrostatic value, and the second touch feedback mode is a feedback mode adopting a relatively large electrostatic value.

At time T1, a first user powers on the tablet PC and uses the tablet PC to browse pictures.

At time T2, the first user slides the thumb and index finger outward on the surface of the display screen to zoom in a first image.

When detecting a touch operation executed through the sliding of the thumb and index finger, the tablet PC generates a zoom-in instruction so as to enlarge the display size of the first image once.

Then, the tablet PC judges whether the display size of the first image has been successfully enlarged or not. Since the first image has been zoomed in only once at this time, the display size of the first image can be successfully changed. Therefore the first touch feedback mode is adopted to make a feedback, that is, a static electricity with a relatively small electrostatic value is generated by the display screen of the tablet PC, and thereby the thumb and index finger of the first user will have a glass-like haptic impression.

Next, the first image is zoomed in two more times based on the same operations of the user. Since the display size of the first image can still be successfully changed, the first haptic feedback is still adopted, and thereby the thumb and index finger of the first user will still have the glass-like haptic impression.

At time T3, the first user again adopts the same manner to execute a zoom-in operation on the first image. After the tablet PC detects the zoom-in operation, it generates a zoom-in instruction; and it also detects the number of times that the first image has been zoomed in. Since the first image has been zoomed in for three times, the display size of the first image cannot be successfully changed. Therefore a second haptic feedback is adopted, that is, a static electricity with a relatively large electrostatic value is generated by the display screen of the tablet PC, and thereby the thumb and index finger of the first user will have a wood-like haptic impression. After feeling the wood-like haptic impression, the first user determines that the first image cannot be zoomed in any more, and then will no longer perform the zoom-in operation.

### Third Embodiment

Based on the same inventive concept, the third embodiment of the present application provides an electronic device that implements the information processing method introduced in the first embodiment of the present application. The electronic device has a touch display unit that can display one or more interactive objects. The electronic device, for example, is a mobile phone, a tablet PC, a laptop, etc., and it will not be exemplified in detail and restricted that what kind of electronic device it is in this embodiment; while the interactive object, for example, is an image object, a navigation control object, an icon object, a progress bar, etc., and it will not be exemplified in detail and restricted that what kind of object the interactive object is in this embodiment.

Referring to FIG. 4, the electronic device includes the following architecture:

A receiving module 401 for receiving a first touch operation on the interactive object from a first user, the first touch operation being used to execute a first instruction that is for changing a first parameter of the interactive object;

A judging module 402 for judging whether the first parameter of the interactive object has been successfully changed or not, and obtaining a first judgment result;

A first execution module 403 for executing a first touch feedback when the first judgment result indicates that the first parameter of the interactive object has been successfully changed; and

A second execution module 404 for executing a second touch feedback when the first judgment result indicates that the first parameter of the interactive object cannot be successfully changed.

In the specific implementing process, the first touch operation received by the receiving module 401 may be an arbitrary operation, for example, a single-click operation, a sliding operation, a double-click operation, etc. After receiving the first touch operation, a first instruction for changing the first parameter of the interactive object and corresponding to the first touch operation will be generated. Wherein, based on different interactive objects and/or different touch operations, the first instructions are different, and thereby the changed first parameters of the interactive objects are also different.

In the specific implementing process, based on different interactive objects, the functions of the judging module 402 are also different. Several of these cases will be exemplified below for introduction, and it is certainly not limited to the following several cases in the specific implementing process.

In a first case, when the interactive object is an image object, the judging module 402 is particularly for: judging whether a display size of the image object has been successfully changed or not.

In a second case, when the interactive object is a navigation control object, the judging module 402 is particularly for: judging whether a distance of the navigation control object with respect to a first position has been successfully changed or not.

In a third case, when the interactive object is an icon object corresponding to at least one short message, the judging module 402 is particularly for: judging whether a display area of the icon object has been successfully changed or not.

In a fourth case, when the interactive object is a progress bar, the judging module 402 is particularly for: judging whether a valid progress value of the progress bar has been successfully changed or not.

Since the several judging processes mentioned above have already been introduced in detail in the first embodiment of the present application, no more detail will be repeated here.

From the above description, it can be known that, in the embodiments of the present application, the interactive object may be multiple types of interactive objects, such as image objects, navigation control objects, icon objects, progress bars, etc., and the first touch operations on these multiple types of interactive objects all can generate corresponding touch feedbacks, thereby achieving the technical effect that the control over the electronic device becomes more diversified.

In the specific implementing process, the first execution module 403 particularly includes:

a first generating unit for generating a first prompt instruction when the first judgment result indicates that the first parameter of the interactive object has been successfully changed; and

a first executing unit for executing the first prompt instruction to generate first prompt information, wherein the first prompt information particularly is: prompt information prompting the first user that the interactive object has been successfully changed.

In the specific implementing process, the first prompt information may be a variety of prompt information, several among which will be exemplified below for introduction, and it is certainly not limited to the following several cases in the specific implementing process.

In a first case, the first prompt information particularly is: prompt information that prompts by way of adopting first preset voice information.

In a second case, the first prompt information particularly is: prompt information that prompts by adopting a first preset vibration mode.

In a third case, the first prompt information particularly is: prompt information that prompts by adopting a first haptic feedback mode.

And in the specific implementing process, the first haptic feedback mode may further be divided into a number of situations, such as \textcircled{1} a feedback mode of generating a static electricity with a first preset electrostatic value on a surface of the touch display unit; \textcircled{2} a feedback mode of adopting a first preset number of motors to vibrate; and \textcircled{3} a feedback mode of generating a first preset number of bumps on the surface of the touch display unit. It is certainly not limited to these three situations in the specific implementing process.

In the specific implementing process, the second executing module particularly includes:

a second generating unit for generating a second prompt instruction when the first judgment result indicates that the first parameter of the interactive object cannot be successfully changed; and

a second executing unit for executing the second prompt instruction to generate second prompt information, wherein the second prompt information particularly is: prompt information prompting the first user that the interactive object cannot be successfully changed.

In the specific implementing process, the second prompt information may be a variety of prompt information, several among which will be exemplified below for introduction, and it is certainly not limited to the following several cases in the specific implementing process.

In a first case, the second prompt information particularly is: prompt information that prompts by way of adopting second preset voice information.

In a second case, the second prompt information particularly is: prompt information that prompts by adopting a second preset vibration mode.

In a third case, the second prompt information particularly is: prompt information that prompts by adopting a second haptic feedback mode.

Wherein, the second haptic feedback mode may be further divided into a number of situations, such as \textcircled{1} a feedback mode of generating a static electricity with a second preset electrostatic value on a surface of the touch display unit; \textcircled{2} a feedback mode of adopting a second preset number of motors to vibrate; and \textcircled{3} a feedback mode of generating a second preset number of bumps on the surface of the touch display unit. It is certainly not limited to these three situations in the specific implementing process.

From the above description, it can be known that, in the embodiments of the present application, the first touch feedback or the second touch feedback can be executed by adopting multiple modes, such as the feedback mode adopting voice prompt, the feedback mode adopting vibration, the feedback mode adopting haptic impression, etc., therefore the technical effect that the feedback modes to the touch operations become more diversified is achieved.

The electronic device introduced in the third embodiment of the present application is the electronic device that is adopted to implement the information processing method in the first embodiment of the present application, thus those skilled in the art can understand the specific implementing modes of the electronic device in this embodiment and various variations thereto based on the information processing method introduced in the first embodiment of the present application, and therefore no more detail will be introduced for the electronic device here. All electronic devices fall into the protection scope claimed by the present application as long as they are the electronic devices adopted by those skilled in the art to implement the information processing method in the first embodiment of the present application.

One or more technical solutions provided by the present application at least have the following technical effects or advantages:

(1) In the embodiments of the present application, after the electronic device receives the first touch operation on the interactive object from the first user, it will judge whether the first instruction executed based on the first touch operation can change the first parameter of the interactive object or not, and further generate different touch feedbacks based on whether the first parameter can be successively changed or not, therefore the technical problem of being incapable of prompting whether the first parameter of the interactive object can be successfully changed or not in the prior arts is solved, and the technical effect of generating different touch feedbacks based on whether the first parameter of the interactive object can be successfully changed or not is achieved;

(2) In the embodiments of the present application, the interactive object may be multiple types of interactive objects, such as image objects, navigation control objects, icon objects, progress bars, etc., and the first touch operations on these multiple types of interactive objects all can generate corresponding touch feedbacks, therefore the technical effect that the control over the electronic device becomes more diversified is achieved; and

(3) In the embodiments of the present application, the first touch feedback or the second touch feedback can be executed by adopting multiple modes, such as the feedback mode adopting voice prompt, the feedback mode adopting vibration, the feedback mode adopting haptic impression, etc., therefore the technical effect that the feedback modes to the touch operations become more diversified is achieved.

Although the preferred embodiments of the present disclosure have already been described, those skilled in the art can make additional variations or modifications to these embodiments once they learn the basic inventive concepts. Therefore, the appended claims are intended to be interpreted as including the preferred embodiments and all the variations and modifications that fall into the scope of the present invention.

Obviously, those skilled in the art can make various variations and modifications to the present disclosure without departing from the spirits and scopes of the present invention. In this way, if these modifications and variations to the present disclosure fall into the scope of the claims of the present disclosure and their equivalents, the present disclosure is also intended to include these variations and modifications.

1. An information processing method applied to an electronic device having a touch display unit that can display one or more interactive objects, the method comprising:
receiving a first touch operation on the interactive object from a first user, the first touch operation being used to execute a first instruction that is for changing a first parameter of the interactive object;
judging whether the first parameter of the interactive object has been successfully changed or not, and obtaining a first judgment result;
executing a first touch feedback when the first judgment result indicates that the first parameter of the interactive object has been successfully changed; and
executing a second touch feedback when the first judgment result indicates that the first parameter of the interactive object cannot be successfully changed.

2. The method according to claim 1, wherein when the interactive object is an image object, the judging whether the first parameter of the interactive object has been successfully changed or not particularly is:
judging whether a display size of the image object has been successfully changed or not.

3. The method according to claim 1, wherein when the interactive object is a navigation control object, the judging whether the first parameter of the interactive object has been successfully changed or not particularly is:
judging whether a distance of the navigation control object with respect to a first position has been successfully changed or not.

4. The method according to claim 1, wherein when the interactive object is an icon object corresponding to at least one short message, the judging whether the first parameter of the interactive object has been successfully changed or not particularly is:
judging whether a display area of the icon object has been successfully changed or not.

5. The method according to claim 1, wherein when the interactive object is a progress bar, the judging whether the first parameter of the interactive object has been successfully changed or not particularly is:
judging whether a valid progress value of the progress bar has been successfully changed or not.

6. The method according to claim 1, wherein the executing a first touch feedback when the first judgment result indicates that the first parameter of the interactive object has been successfully changed particularly includes:
generating a first prompt instruction when the first judgment result indicates that the first parameter of the interactive object has been successfully changed; and
executing the first prompt instruction to generate first prompt information, the first prompt information particularly being: prompt information prompting the first user that the interactive object has been successfully changed.

7. The method according to claim 1, wherein the executing a second touch feedback when the first judgment result indicates that the first parameter of the interactive object cannot be successfully changed particularly includes:
generating a second prompt instruction when the first judgment result indicates that the first parameter of the interactive object cannot be successfully changed; and
executing the second prompt instruction to generate second prompt information, the second prompt information particularly being: prompt information prompting the first user that the interactive object cannot be successfully changed.

8. The method according to claim 6, wherein the first prompt information particularly is: prompt information that prompts by way of adopting first preset voice information; or prompt information that prompts by adopting a first preset vibration mode; or prompt information that prompts by adopting a first haptic feedback mode.

9. The method according to claim 8, wherein the first haptic feedback mode particularly is: a feedback mode of generating a static electricity with a first preset electrostatic value on a surface of the touch display unit; or
the first haptic feedback mode particularly is: a feedback mode of adopting a first preset number of motors to vibrate.

10. The method according to claim 7, wherein the second prompt information particularly is: prompt information that prompts by way of adopting second preset voice information; or prompt information that prompts by adopting a second preset vibration mode; or prompt information that prompts by adopting a second haptic feedback mode.

11. The method according to claim 10, wherein the second haptic feedback mode particularly is: a feedback mode of generating a static electricity with a second preset electrostatic value on a surface of the touch display unit; or
the second haptic feedback mode particularly is: a feedback mode of adopting a second preset number of motors to vibrate.

12. An electronic device having a touch display unit that can display one or more interactive objects, the electronic device comprising:
a receiving module for receiving a first touch operation on the interactive object from a first user, the first touch operation being used to execute a first instruction that is for changing a first parameter of the interactive object;
a judging module for judging whether the first parameter of the interactive object has been successfully changed or not, and obtaining a first judgment result;
a first executing module for executing a first touch feedback when the first judgment result indicates that the first parameter of the interactive object has been successfully changed; and
a second executing module for executing a second touch feedback when the first judgment result indicates that the first parameter of the interactive object cannot be successfully changed.

13. The electronic device according to claim 12, wherein when the interactive object is an image object, the judging module is particularly for:
judging whether a display size of the image object has been successfully changed or not.

14. The electronic device according to claim 12, wherein when the interactive object is a navigation control object, the judging module is particularly for:
judging whether a distance of the navigation control object with respect to a first position has been successfully changed or not.

15. The electronic device according to claim 12, wherein when the interactive object is an icon object corresponding to at least one short message, the judging module is particularly for:
judging whether a display area of the icon object has been successfully changed or not.

16. The electronic device according to claim 12, wherein when the interactive object is a progress bar, the judging module is particularly for:
judging whether a valid progress value of the progress bar has been successfully changed or not.

17. The electronic device according to claim 12, wherein the first executing module particularly includes:
a first generating unit for generating a first prompt instruction when the first judgment result indicates that the first parameter of the interactive object has been successfully changed; and
a first executing unit for executing the first prompt instruction to generate first prompt information, the first prompt information particularly being: prompt information prompting the first user that the interactive object has been successfully changed.

18. The electronic device according to claim 12, wherein the second executing module particularly includes:
a second generating unit for generating a second prompt instruction when the first judgment result indicates that the first parameter of the interactive object cannot be successfully changed; and
a second executing unit for executing the second prompt instruction to generate second prompt information, the second prompt information particularly being: prompt information prompting the first user that the interactive object cannot be successfully changed.

19. The electronic device according to claim 17, wherein the first prompt information particularly is: prompt information that prompts by way of adopting first preset voice information; or prompt information that prompts by adopting a first preset vibration mode; or prompt information that prompts by adopting a first haptic feedback mode.

20. The electronic device according to claim 19, wherein the first haptic feedback mode particularly is: a feedback mode of generating a static electricity with a first preset electrostatic value on a surface of the touch display unit; or
the first haptic feedback mode particularly is: a feedback mode of adopting a first preset number of motors to vibrate.

21. The electronic device according to claim 18, wherein the second prompt information particularly is: prompt information that prompts by way of adopting second preset voice information; or prompt information that prompts by adopting a second preset vibration mode; or prompt information that prompts by adopting a second haptic feedback mode.

22. The electronic device according to claim 21, wherein the second haptic feedback mode particularly is: a feedback mode of generating a static electricity with a second preset electrostatic value on a surface of the touch display unit; or
the second haptic feedback mode particularly is: a feedback mode of adopting a second preset number of motors to vibrate.
